(19) United States
(12) Patent Application Publication
(10) Pub. No.: US 2026/0323661 A1
(43) Pub. Date: Oct. 15, 2026

(54) METHODS FOR PDU DUPLICATION IN MULTICARRIER SIDELINK

(71) Applicant: INTERDIGITAL PATENT HOLDINGS, INC., Wilmington, DE (US)

(72) Inventors: Martino Freda, Laval (CA); Tuong Hoang, Montreal (CA); Faris Alfarhan, Montreal (CA); Tao Deng, New York, NY (US)

(73) Assignee: INTERDIGITAL PATENT HOLDINGS, INC., Wilmington, DE (US)

(21) Appl. No.: 19/101,136

(22) PCT Filed: Aug. 4, 2023
(86) PCT No.: PCT/US2023/029561

§ 371 Date: Feb. 4, 2025

Related U.S. Application Data
(60) Provisional application No. 63/395,223, filed on Aug. 4, 2022.

(51) Int. Cl. H04W 72/25; H04L 69/322

(52) U.S. Cl. CPC H04W 72/25; H04L 69/322

(57) ABSTRACT

A system, wireless device and method for PDU duplication in multicarrier sidelink are disclosed. The method may include the wireless device determining duplication behavior based on QoS of data to be transmitted, CBR, sensing results, and/or resource selection results, HARQ feedback, SL channel measurements reported by a peer WTRU, and RX WTRU explicit indication/request. The method may also include the wireless device determining how long to maintain duplication activated. The method may also include the wireless device bring configured with a prohibit mechanism for enabling duplication. The method may also include the duplication behavior depending on cast type associated with the SLRB.

### CROSS-REFERENCE TO RELATED APPLICATIONS

This application claims the benefit of U.S. Provisional Application No. 63/395,223, filed Aug. 4, 2022, the contents of which are incorporated herein by reference.

### BACKGROUND

Vehicular communication is a mode of communication whereby WTRUs communicate with each other directly. There are two scenarios for V2X operations. In an in-coverage scenario, WTRUs receive assistance from the network to start transmitting and receiving V2X messages. In an out-of-coverage scenario, WTRUs use some pre-configured parameters to start transmitting and receiving V2X messages.

V2X communication is supported in LTE, and was inspired from the previous work on Device-to-Device (D2D) communications. V2X communication services may encompass four different types of communication services: V2V (Vehicle to Vehicle) where vehicular WTRUs communicate with each other directly, V2I (Vehicle to infrastructure) where vehicular WTRUs communicate with the RSUs/eNBs, V2N (Vehicle to Network) where vehicular WTRUs communicate with the core network, and V2P (Vehicle to Pedestrian) where vehicular WTRUs communicate with WTRUs based on special conditions, e.g., low battery capacity.

### SUMMARY

A system, wireless device and method for PDU duplication in multicarrier sidelink are disclosed. The wireless device is configured to perform the method. The wireless device includes a receiver, a transmitter operatively coupled to the receiver, and a processor operatively coupled to the receiver and the transmitter. Alternatively, the wireless device includes a transceiver, and a processor operatively coupled to the transceiver.

The method may include the wireless device determining duplication behavior based on QoS of data to be transmitted. The method may also include the wireless device determining duplication behavior based on CBR, possibly measured on one or multiple SL carriers. The method may also include the wireless device determining duplication behavior based on sensing results, and/or resource selection results. The method may also include the wireless device determining duplication behavior based on HARQ feedback. The method may also include the wireless device determining duplication behavior based on SL channel measurements reported by a peer WTRU. The method may also include the wireless device determining duplication behavior based on RX WTRU explicit indication/request. The method may also include the wireless device determining how long to maintain duplication activated. The method may also include the wireless device bring configured with a prohibit mechanism for enabling duplication. The method may also include the duplication behavior depending on cast type associated with the SLRB.

The wireless device may be a wireless transmit receive unit (WTRU), a base station, an eNode-B, a gNB, a transmission/reception point (TRP), a vehicle, a vehicular WTRU, a network node, an access point (AP), a station (STA), and a relay node.

A system and method are disclosed. The system and method may be performed in wireless transmit and receive unit (WTRU) to provide duplication on a plurality of sidelink (SL) carriers. The system and method include receiving a configuration for sidelink radio bearer (SLRB), enabling packet data convergence protocol (PDCP) duplication for the SLRB based on sensing results to a condition from the configuration, duplicating all protocol data units (PDUs) from the SLRB on two of the plurality of SL carriers for a configured period of time following the enabling, and monitoring for a duplication disable condition for the SLRB.

The sensing results may include a determination that a condition for SLRB is satisfied. The configuration for SLRB may include a threshold time difference between a selected resource and a packet delay budget (PDB). The threshold time difference may be for each SLRB. The configuration for SLRB may include a period of time to duplicate PDUs. The period of time may be for each SLRB. The condition for SLRB may be an arrival of data. The condition for SLRB may include a time difference between a selected resource and a PDB of available data is less than a threshold time difference. The duplication condition for SLRB may include preemption. The duplication condition for SLRB may include remaining PDB.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed examples may be implemented;

FIG. 1B is a system diagram illustrating an example wireless transmit/receive unit (WTRU) that may be used within the communications system illustrated in FIG. 1A according to an example;

FIG. 1C is a system diagram illustrating an example radio access network (RAN) and an example core network (CN) that may be used within the communications system illustrated in FIG. 1A according to an example;

FIG. 1D is a system diagram illustrating a further example RAN and a further example CN that may be used within the communications system illustrated in FIG. 1A according to an example;

FIG. 2 illustrates a method for duplication and duplication behavior generally as described herein;

FIG. 3 illustrates a method performed in wireless transmit and receive unit (WTRU) to provide duplication on a plurality of sidelink (SL) carriers; and

FIG. 4 illustrates an example of the method of PDU duplication in a multicarrier sidelink.

### DETAILED DESCRIPTION

A system, wireless device and method for PDU duplication in multicarrier sidelink are disclosed. The wireless device is configured to perform the method. The wireless device includes a receiver, a transmitter operatively coupled to the receiver, and a processor operatively coupled to the receiver and the transmitter. Alternatively, the wireless device includes a transceiver, and a processor operatively coupled to the transceiver.

The method may include the wireless device determining duplication behavior based on QoS of data to be transmitted. The method may also include the wireless device determining duplication behavior based on CBR, possibly measured on one or multiple SL carriers. The method may also include the wireless device determining duplication behavior based on sensing results, and/or resource selection results. The method may also include the wireless device determining duplication behavior based on HARQ feedback. The method may also include the wireless device determining duplication behavior based on SL channel measurements reported by a peer WTRU. The method may also include the wireless device determining duplication behavior based on RX WTRU explicit indication/request. The method may also include the wireless device determining how long to maintain duplication activated. The method may also include the wireless device bring configured with a prohibit mechanism for enabling duplication. The method may also include the duplication behavior depending on cast type associated with the SLRB.

The wireless device may be a wireless transmit receive unit (WTRU), a base station, an eNode-B, a gNB, a transmission/reception point (TRP), a vehicle, a vehicular WTRU, a network node, an access point (AP), a station (STA), and a relay node.

A system and method are disclosed. The system and method may be performed in wireless transmit and receive unit (WTRU) to provide duplication on a plurality of sidelink (SL) carriers. The system and method include receiving a configuration for sidelink radio bearer (SLRB), enabling packet data convergence protocol (PDCP) duplication for the SLRB based on sensing results to a condition from the configuration, duplicating all protocol data units (PDUs) from the SLRB on two of the plurality of SL carriers for a configured period of time following the enabling, and monitoring for a duplication disable condition for the SLRB.

The sensing results may include a determination that a condition for SLRB is satisfied. The configuration for SLRB may include a threshold time difference between a selected resource and a packet delay budget (PDB). The threshold time difference may be for each SLRB. The configuration for SLRB may include a period of time to duplicate PDUs. The period of time may be for each SLRB. The condition for SLRB may be an arrival of data. The condition for SLRB may include a time difference between a selected resource and a PDB of available data is less than a threshold time difference. The duplication condition for SLRB may include preemption. The duplication condition for SLRB may include remaining PDB.

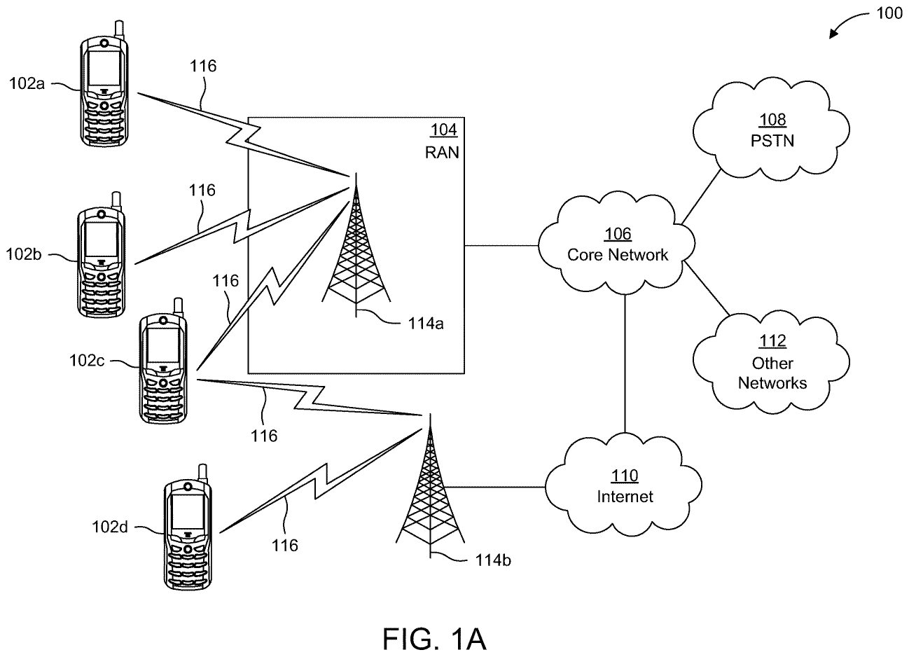

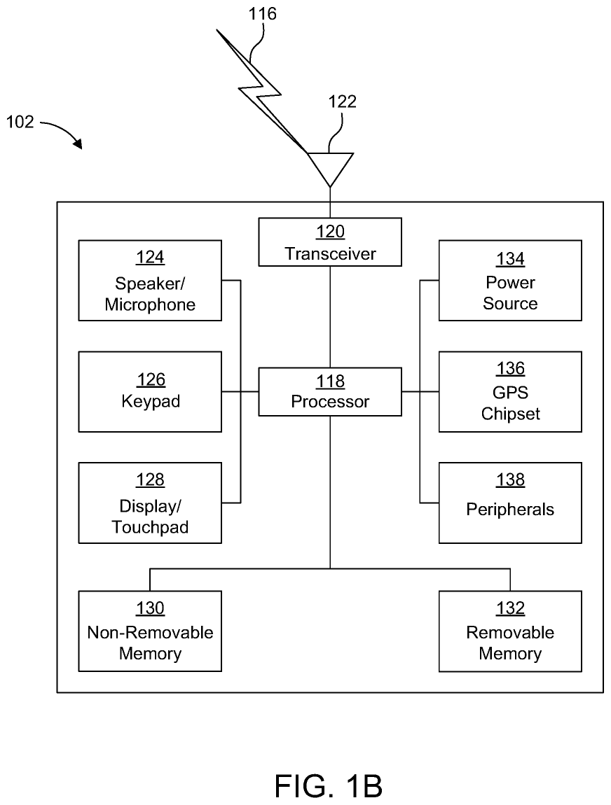

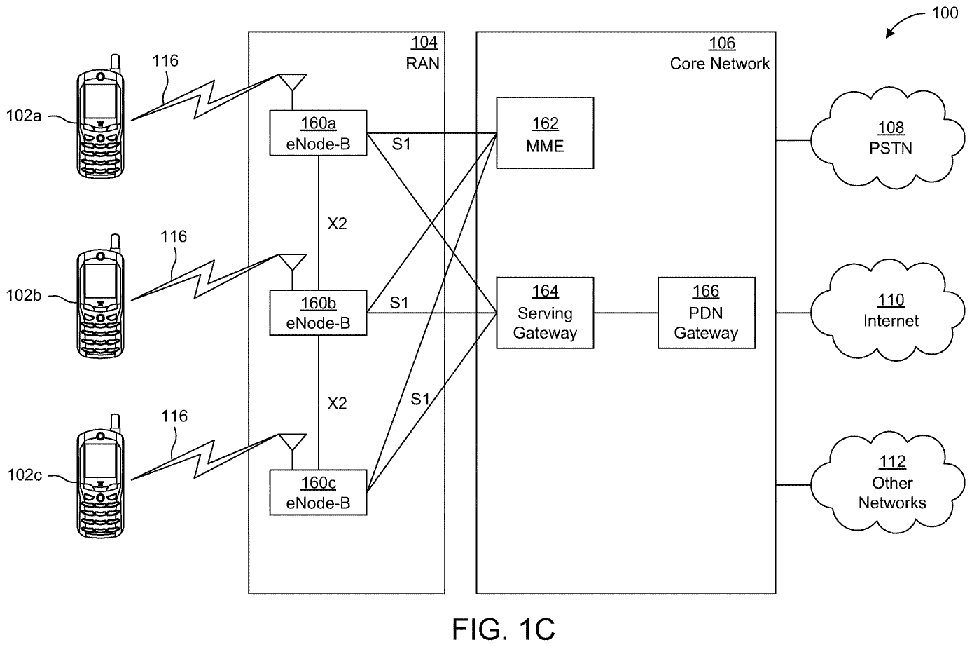

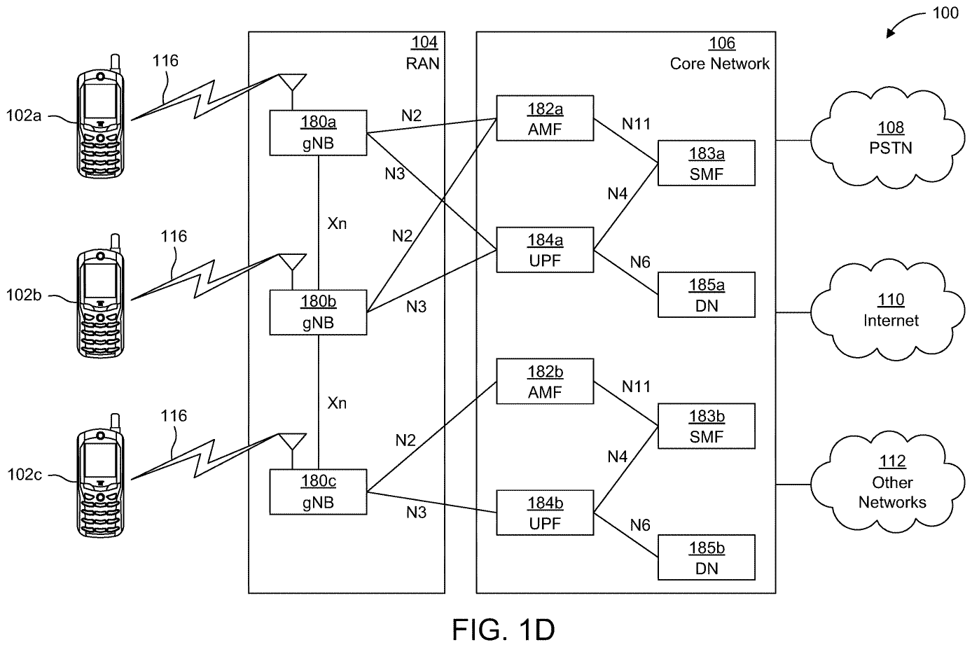

FIG. 1A is a diagram illustrating an example communications system 100 in which one or more disclosed examples may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed examples contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one example, the base station 114a may include three transceivers, i.e., one for each sector of the cell. In an example, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an example, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an example, the base station 114a and the WTRUs 102a, 102b, 102c may implement a radio technology such as NR Radio Access, which may establish the air interface 116 using NR.

In an example, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other examples, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one example, the base station 114b and the WTRUs 102c, 102d may implement a radio technology such as IEEE 802.11 to establish a wireless local area network (WLAN). In an example, the base station 114b and the WTRUs 102c, 102d may implement a radio technology such as IEEE 802.15 to establish a wireless personal area network (WPAN). In yet another example, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an example.

The processor 118 may be a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one example, the transmit/receive element 122 may be an antenna configured to transmit and/or receive RF signals. In an example, the transmit/receive element 122 may be an emitter/detector configured to transmit and/or receive IR, UV, or visible light signals, for example. In yet another example, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one example, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other examples, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an example.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an example, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an example. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an example. The eNode-Bs 160a, 160b, 160c may each include one or more transceivers for communicating with the WTRUs 102a, 102b, 102c over the air interface 116. In one example, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative examples that such a terminal may use (e.g., temporarily or permanently) wired communication interfaces with the communication network.

In representative examples, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative examples, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative examples, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative example, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an example. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an example. The gNBs 180a, 180b, 180c may each include one or more transceivers for communicating with the WTRUs 102a, 102b, 102c over the air interface 116. In one example, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an example, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an example, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QOS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one example, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

V2X resource allocation is provided in LTE. LTE defines two modes of operation in V2X communication. One mode where the network gives the WTRU a scheduling assignment for V2X sidelink transmission, often referred to as Mode 3. Another mode where the WTRU autonomously selects the resources from a configured/pre-configured resource pool, often referred to as Mode 4. V2X LTE defines two categories of resource pools including receiving pools which are monitored for receiving V2X transmission, and V2X transmitting pools which are used by WTRUs to select the transmission resource in Mode 4. Transmitting pools are not generally used by WTRUs configured in Mode 3.

The resource pools are semi-statically signaled to WTRUs via RRC signaling. In Mode 4, the WTRU may use sensing before selecting a resource from the RRC configured transmitting pool. LTE V2X generally does not support dynamic resource pools reconfiguration as pool configuration may only be carried via SIB and/or dedicated RRC signaling.

New Radio (NR) V2X Resource Allocation is provided. NR inherited the two modes of resource allocation from LTE. One mode of resource allocation is gNB scheduled resource allocation often referred to as Mode 1 resource allocation. Another mode of resource allocation is WTRU autonomous resource allocation often referred to as Mode 2 resource allocation. The concept of resource pools and sensing for mode 2 resource allocation was also inherited from LTE.

LTE includes a multicarrier sidelink (SL) transmission. Carrier aggregation (CA) in sidelink is supported for V2X sidelink communication. CA may apply to both in-coverage WTRUs and out-of-coverage WTRUs. For CA in sidelink, neither primary component carrier nor secondary component carriers are defined. Each resource pool (pre)configured for V2X sidelink communication transmission or reception is associated with a single carrier. When a WTRU supporting CA in sidelink uses autonomous resource selection, the WTRU performs carrier selection and may select one or more carriers used for V2X sidelink communication transmission. The carrier selection is performed at the MAC layer, depending on the CBR of the (pre)configured carriers for V2X sidelink communication and the PPPP(s) of the V2X messages to be transmitted. The carrier reselection may be performed when resource reselection is triggered and is triggered for each sidelink process. In order to avoid frequent switching across different carriers, the WTRU may keep using a carrier already selected for transmission, if the measured CBR on this carrier is lower than a (pre)configured threshold. Selected carriers may have the same synchronization reference or the same synchronization priority configuration. For a WTRU using autonomous resource selection, logical channel prioritization is performed for a sidelink resource on a carrier depending on the CBR measured on the carrier and the PPPP of the sidelink logical channels.

There is duplication in NR Uu. To support uplink periodic traffic of services with survival time requirement, configured grant resources may be used such that the mapping relation between the service and the configured grant is known to both gNB and WTRU. This allows the gNB to use configured grant retransmission scheduling (addressed by CS-RNTI) to trigger survival time state entry for the corresponding DRB. Upon survival time state entry, RLC entities configured for the DRB are activated by the WTRU for duplication to prevent failure of subsequent messages to fulfill the survival time requirement. If CA or DC duplication for the DRB is already activated, the DRB may enter survival time state when any retransmission grant for any of its active LCHs is received.

In LTE, duplication is enabled based on PPPR-if the PPPR of the packet is above a threshold, the WTRU performs duplication on two different carriers. For NR, in order to support more stringent reliability requirements, duplication on multiple carriers may be supported. The duplication may be controlled more dynamically and turned on as when needed to avoid significant increased sidelink resource usage.

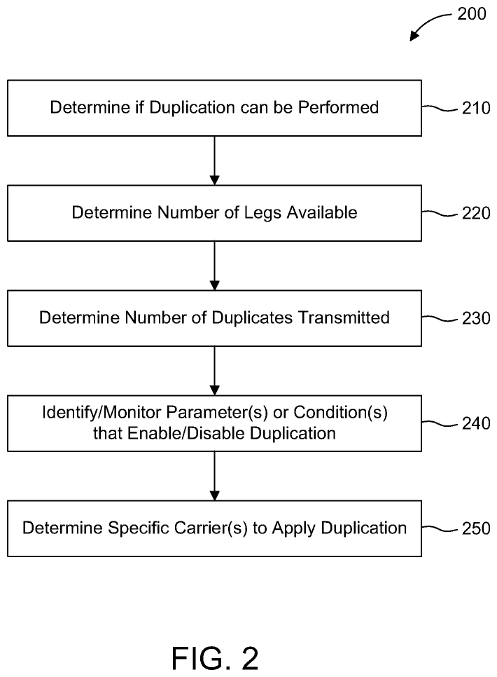

FIG. 2 illustrates a method 200 for duplication and duplication behavior generally as described herein. Method 200 includes a determination 210 of whether duplication can be performed by a WTRU. Determination 210 may include whether the duplication is associated with a SLRB and when other conditions, such as those described herein are met. Method 200 includes a determination 220 of the number (maximum, minimum) of RLC legs associated with a SLRB. Method 200 includes a determination 230 of the number (maximum, minimum) of PDCP duplicates that are transmitted by a WTRU for each PDCP PDU. This determination 230 may include duplicates that are in on SL carrier and possibly in different SL carriers. Method 200 includes identifying/monitoring 240 parameter(s) or condition(s) that enable/disable duplication. This identifying/monitoring may include any parameter or condition associated with determining whether/when to enable/disable duplication of a PDCP PDU (for example, CBR thresholds to enable/disable duplication, HARQ NACK thresholds to enable/disable duplication, etc.). For example, a SLRB may be configured with multiple RLC legs (duplication allowed) using a first condition, and duplication may later be turned on or off based on a second condition. Method 200 includes determining 250 specific carrier(s) to apply duplication. For example, the specific carrier(s) over which duplication may or is to be applied. For example, duplicate RLC channels may be configured over different carriers, and the WTRU may use one or more of the carriers for duplication of PDCP based on certain conditions and the actual criteria, conditions, parameters used in the conditions, etc., used to determine whether to do duplication, the number of duplicates, etc.

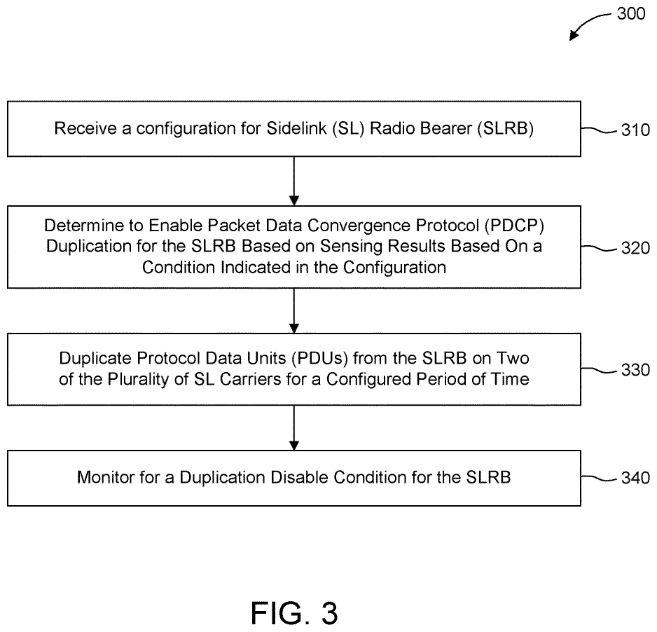

FIG. 3 illustrates a method 300 performed in wireless transmit and receive unit (WTRU) to provide duplication on a plurality of sidelink (SL) carriers. Method 300 includes receiving 310 a configuration for sidelink (SL) radio bearer (SLRB). Method 300 includes determining to enable 320 packet data convergence protocol (PDCP) duplication for the SLRB based on sensing results. The sensing results may be based on the condition provided in the configuration. The WTRU may determine duplication behavior based on one or more factors. The factors may be used independently, or in combination, to come up with a condition(s) for enabling/disabling duplication based on a condition that includes a combination of factors described herein.

A WTRU may determine duplication behavior based on QoS of data to be transmitted. In one example, a WTRU may determine duplication behavior based on the QoS of the data to be transmitted. Specifically, the WTRU may be configured with a mapping of SL bearer to duplication parameter or duplication behavior. Alternatively, the WTRU may be configured with a mapping of QoS flow or PQI parameter to duplication behavior.

In one example, a WTRU may be configured with a CBR threshold for determining whether to perform duplication. The CBR threshold may be (pre)configured per SLRB. For example, if the CBR is above/below a SLRB-specific threshold, the WTRU may perform duplication of PDUs associated with the SLRB.

In another example, a WTRU may be configured with a number of RLC entities for a given SLRB. Specifically, the WTRU may determine the number of RLC entities based on the SLRB configuration. The WTRU may create the bearer. The WTRU may determine whether to duplicate to each RLC entity, and the number of entities, based on other conditions herein.

A WTRU may determine duplication behavior based on CBR. This may be measured on one or multiple SL carriers. In one example, a WTRU determines duplication behavior based on the measured CBR on one or multiple SL carriers. The WTRU may determine the duplication behavior based on a myriad of factors described below applied alone or in combination.

The CBR of the carrier with the highest/lowest CBR among the selected carriers. For example, if the carrier with the largest measured CBR among the selected carriers has a CBR below a threshold, the WTRU may perform duplication. For example, if the carrier with the smallest measured CBR among the selected carriers has a CBR below a threshold, the WTRU may perform duplication.

The average CBR measured on the selected carriers. For example, if the average CBR measurement among the selected carriers is below a threshold, the WTRU may perform duplication.

The range or difference in CBR between the carriers, including on which duplication may be performed, with the highest CBR and lowest CBR. For example, if the difference in CBR between the selected carrier with the highest CBR and the carrier with the lowest CBR is above/below a threshold, the WTRU may perform duplication on the selected carriers.

CBR thresholds may be used to determine whether duplication can be performed and may further be configured based on other criteria, such as: a CBR threshold per priority of the data being considered for duplication, a CBR threshold for a given number of carriers over which duplication is configured for a bearer, or decided by the WTRU for a bearer, a CBR threshold for each SLRB for which duplication of packets is being considered, a CBR threshold for a given number of carriers a WTRU has selected for transmission, or is allowed to perform transmission on.

A WTRU may determine duplication behavior based on sensing results, and/or resource selection results. In one example, a Mode 2 WTRU determines duplication behavior based on sensing results or any conditions associated with sensing. Such conditions may include whether the WTRU detects the need to perform preemption on a resource. For example, the WTRU may enable duplication when it triggers preemption on one of its selected and indicated resources. The resource may be configured to be used for a bearer that enables such behavior for duplication. For example, the WTRU may enable duplication when the WTRU triggers re-evaluation of a selected resource, even if the resource is not yet indicated. The conditions may include whether the WTRU selects resources after increasing the RSRP threshold for determining availability of resources by 3 dB. For example, the WTRU may enable duplication if, at a given instance of resource selection, the WTRU increased the RSRP threshold by 3 dB a number of times N (where N could be 1, or larger than 1) in order to achieve the percentage of available resources for successful resource selection. The conditions may be based on a condition associated with the number of available resources during resource selection, either on one carrier or multiple carriers. For example, the WTRU may be configured with a threshold percentage of available resources (or an offset from the percentage configured for successful resource selection for a given priority). If the percentage of available resources is below the threshold, the WTRU may enable duplication. The conditions may be based on a condition associated with the time difference between the PDB/remaining PDB and the selected resource, or of the remaining PDB itself. For example, if the remaining PDB at the time of resource selection is below a threshold, the WTRU may enable duplication. For example, if the time between the PDB used for resource selection, and the actual selected resource is smaller than a threshold, the WTRU may enable duplication. The conditions may be based on a condition associated with the relationship between the resources selected in different carriers. For example, the WTRU may have resources selected in different carriers. The WTRU may determine whether to enable duplication based on the relationship between these resources (e.g., frequency difference, time difference, etc.). For example, if the WTRU has resources in different carriers which are spaced by at least/at most a threshold time, the WTRU may enable duplication. The conditions may be based on the quality of a selected resource. For example, the WTRU may determine whether to enable duplication based on the measured RSRP of any SCI indicating the resource to be occupied. Specifically, if the resource is reserved by another WTRU and the RSRP of the SCI reserving such resource is above a threshold, the WTRU may enable duplication.

In any of the described examples, the resource selection criteria for enabling duplication may be triggered on a single carrier. Specifically, if one or more of the above conditions is satisfied in any carrier in which the WTRU can perform transmission, such as for a specific SLRB, the WTRU may initiate duplication. Alternatively, duplication may be enabled if the condition is satisfied on several or all of the carriers. Specifically, there may be a number of carriers (either configured, or determined based on criteria described herein) which, when any of the condition is satisfied for each of the carriers, enables duplication.

In any of the described examples, the WTRU may enable duplication on one or multiple SLRB which allow duplication. For example, the WTRU may enable duplication on all SLRBs which allow duplication. For example, the specific SLRBs on which duplication is enabled may be determined based on the specific condition itself. For example, a bearer may be configured with a specific threshold of PDB to resource difference, and duplication may be enabled for a bearer when a selected resource meets that threshold. Alternatively, another condition may be used to determine which SLRBs have duplication enabled following fulfillment of a first condition. For example, following the determination to enable duplication on one or more SLRBs as a result of a resource selection condition, the WTRU may determine which SLRBs on which to enable duplication based on the measured CBR and comparison to a configured CBR threshold.

The WTRU may determine duplication behavior based on HARQ feedback. In one example, a WTRU may determine duplication based on reception/non-reception of HARQ feedback. Specifically, a WTRU may use a rule defined by the reception of ACK/NACK/DTX to determine whether to enable (and/or possibly whether to disable) duplication on one or more SLRBs. The rule may be defined based on the number of consecutive ACK/NACK/DTX received. For example, a WTRU may enable duplication if the number of consecutive NACK or DTX exceeds a threshold. Once duplication is enabled, the specific SLRBs on which duplication is enabled may further depend on the number of consecutive NACK/DTX. Specifically, the threshold number of consecutive NACK/DTX for enabling duplication for a SLRB may be configured per priority or per SLRB. For example, a WTRU may disable duplication (on a specific SLRB, or on all SLRBs which have duplication enabled) when the number of consecutive ACKs received on SL is above a threshold. The rule may be defined based on the number of ACK/NACK/DTX received in a configured time period. The rule may be defined based on the number of ACK/NACK/DTX received from different WTRUs in a groupcast HARQ scenario. For example, if the ratio of ACK to NACK is below a threshold, the WTRU may enable duplication. For example, if the number of WTRUs which send NACK for a specific TB is larger than a threshold, the WTRU may enable duplication. For example, if at least X WTRUs send ACK for a specific TB and duplication is enabled, the WTRU may disable duplication. The combination of the above rules may be used to determine the duplication behavior.

The WTRU may determine duplication behavior based on SL channel measurements reported by a peer WTRU. In one example, a WTRU may determine the condition for enabling duplication based on the SL channel measurements reported by a peer WTRU, such as CQI, RSRP, CR, CBR (or similar channel occupancy metric associated with a single WTRU) for example. For example, a WTRU may enable duplication if a reported SL measurement from the peer WTRU for one or a set of carriers (e.g., CQI, RSRP) is below a threshold. Similar considerations over multiple carriers (e.g., average CQI/RSRP) may be considered as discussed herein for CBR. For example, a WTRU may be configured with a first condition for enabling duplication, and a second condition for disabling duplication. Such conditions may depend on the reported SL measurements as well as other factors herein (e.g., an amount of time). For example, a WTRU may be configured with a first condition to enable duplication (e.g., CQI below a first threshold) and a second condition to disable duplication (e.g., CQI above a second threshold for a period of time). For example, a WTRU may be configured with a measurement-based condition to determine the number of carriers on which to duplicate. Specifically, the WTRU may duplicate on two carriers if the SL channel measurement reported by the peer WTRU is in a first range, duplicate on three carriers if the SL channel measurement reported by the peer WTRU is in the second range, etc. For example, a WTRU may receive a channel occupancy measure (e.g., CR) from a peer WTRU. Such channel occupancy measure may be defined over multiple carriers/resource pools to represent the amount of time that the WTRU is busy transmitting and consequently unable to receive. Alternatively, multiple measures (e.g., one measure per carrier) may be sent to indicate the occupancy measure per carrier. The TX WTRU may determine to perform duplication if the occupancy measure of one or more carriers (or a combined measure across multiple carriers) is above a threshold. The TX WTRU may decide the number of carriers or the specific carriers to use for duplication based on the occupancy measure(s). Specifically, the TX WTRU may duplicate on the carriers with the lowest occupancy. Specifically, the TX WTRU may duplicate on a number of carriers determined by those which have an occupancy metric below a threshold. Specifically, at least one of the duplicated carriers may be selected from the carriers having an occupancy metric below a threshold. Similar conditions may be used to disable duplication after it is enabled, including after some time in which the condition is met.

Without loss of generality, the same example can be applied using measurements performed by the TX WTRU, as with measurements reported by the peer WTRU.

The WTRU may determine duplication behavior based on RX WTRU explicit indication/request. In one example, a TX WTRU determine the duplication behavior based on explicit/implicit indication from the peer WTRU. Specifically, the peer WTRU may use similar criteria discussed herein to determine whether the TX WTRU's duplication behavior, and the peer WTRU's duplication behavior may be sent to the TX WTRU using implicit or explicit signaling. In one example, the RX WTRU may determine the need for duplication based on counting of ACK/NACK associated with received packets (i.e., decoding success vs. failure). Based on certain criteria associated, for example, with the ratio of ACK vs NACK, the RX WTRU may indicate to the TX WTRU to enable duplication, including for a specific LCH. The TX WTRU may then enable duplication, including for the logical channel/bearer indicated by the TX WTRU.

Method 300 includes duplicating 330 protocol data units (PDUs) from the SLRB on two of the plurality of SL carriers for a configured period of time. The WTRU may determine how long to maintain duplication activated. A WTRU may enable duplication based on one or a combination of triggers/conditions described herein. Following enabling of duplication, the WTRU may maintain duplication for a period of time or until the occurrence of another trigger. For example, the WTRU may be configured with a timer (defining a period of time) to maintain duplication following the trigger to enable duplication. The WTRU may start the timer upon enabling duplication, and following timer expiry (the expiry of the period of time), the WTRU may disable duplication. The WTRU may further determine the value of the timer based on factors associated to QOS. For example, the WTRU may be configured with a timer specific to each SLRB and may set the timer to the value associated with the SLRB with data available at the time of enabling duplication.

Method 300 includes monitoring 340 for a duplication disable condition for the SLRB. Alternatively, or additionally, the WTRU may be configured with a second condition for disabling duplication when duplication is enabled. Such condition may be related to any of the factors described herein, and may or may not be associated with the same factor for enabling duplication. For example, when duplication is enabled, the WTRU may determine to disable duplication based on HARQ feedback received from the peer WTRU. Specifically, following enabling of duplication, if the consecutive number of HARQ ACKs received from a peer WTRU reaches a threshold, the WTRU can disable duplication.

Alternatively, the WTRU may be configured to maintain duplication (once turned on based on one or more of the conditions described) for a number of PDU transmissions for a SLRB. For example, once duplication is turned on by a WTRU following a trigger, the WTRU may perform duplication on all SLRBs configured with duplication for the next N PDUs from each SLRB, where N may be configured per SLRB.

The WTRU may be configured with a prohibit mechanism for enabling duplication. In one example, a WTRU may be configured with a prohibit mechanism for enabling duplication. Specifically, the WTRU may be configured with a condition which does not allow enabling duplication at a specific time. Such a prohibit mechanism may be configured based on the following. The mechanism may be configured based on a time since the last time the WTRU performed duplication. For example, the WTRU may be allowed to enable duplication, including duplication associated with a specific SLRB, no less than a period of time x since the last time duplication was enabled, including duplication associated to that SLRB. The time period may be specific to the SLRB. The time period may depend on the measured CBR. For example, the WTRU may be configured with a minimum time to be respected between disabling duplication and re-enabling duplication, including for the same SLRB, which is dependent on priority and CBR. Specifically, for a given priority and CBR, the WTRU may wait at least X seconds between when duplication was disabled, and when the WTRU can enable duplication for SLRBs associated with a given priority. The mechanism may be configured based on the CBR, or any SL measurements made, since the last time the WTRU performed duplication. For example, the WTRU may be allowed to enable duplication, including associated with a SLRB, if the measured CBR is no higher than the measured CBR the last time duplication was enabled.

The duplication behavior may depend on cast type associated with the SLRB. In one example, duplication behavior may depend on the cast type of the SLRB. For example, a WTRU may be configured with a different maximum number of carriers to use for a given cast type, the conditions checked for enabling and/or disabling duplication may be different for different cast types, the time period in which duplication may remain enabled may be configured differently for each cast type, and the like. In an example, a WTRU determines whether to perform duplication of a PDU on multiple sidelink carriers and the number of carriers to duplicate on based on QoS of the packet, average CBR, and resource (re)selection results. A TX WTRU receives a SL bearer configuration (in SIB/RRC/preconfiguration) containing a maximum number of carriers for a given average CBR allowed for duplication of a PDU containing data from a logical channel of that bearer. The TX WTRU receives data to be transmitted on a SL bearer that allows duplication and performs resource (re)selection. If the time difference between the selected resources and the PDB is less than a threshold, or if the WTRU triggers pre-emption of a selected resource, the TX WTRU enables duplication for the SL bearer on up to the maximum number of configured carriers and turn HARQ feedback to enabled for duplicated LCH (if configured with HARQ feedback disabled) and continues to perform duplication for the SL bearer until the number of consecutive HARQ ACKs to PDUs containing data from the bearer reaches a HARQ ACK threshold.

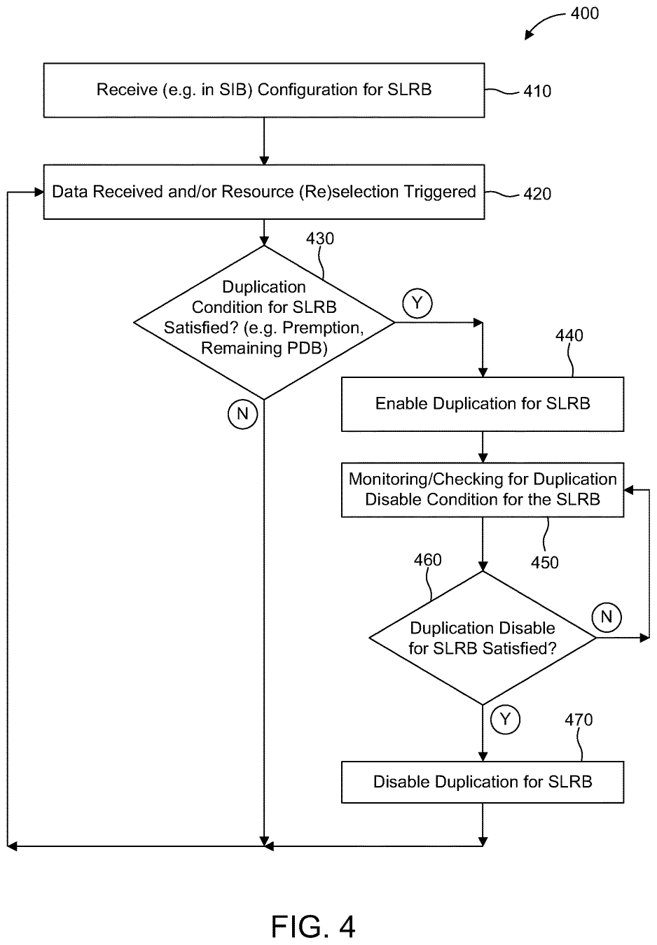

FIG. 4 illustrates an example method 400 for PDU duplication in a multicarrier sidelink. As illustrated in FIG. 4, a TX WTRU may be (pre)configured with a number of protocol entities (e.g., RLC entity or MAC entity) associated with a SLRB. The protocol entities may each be configured to operate over a carrier usable for transmission by the TX WTRU. Specifically, for the case of groupcast, the TX WTRU may be (pre)configured with a protocol for each carrier for which the groupcast L2 ID can be transmitted on. On the other hand, for the case of unicast, the TX WTRU may determine the carriers on which to create protocol used for duplication.

The TX WTRU may further be configured with a maximum number of carriers allowed for duplication for a given congestion level. Specifically, the SLRB configuration may include a mapping of CBR range to maximum number of carriers used for duplication. The TX WTRU may perform CBR measurements on each of the carriers configured for duplication of the SLRB and may determine an average CBR value over the carriers. Based on the average CBR value and the mapping of CBR range to number of carriers, the TX WTRU may determine the maximum number of carriers for duplication of PDUs for that SLRB. The TX WTRU may update the maximum number regularly (e.g., periodically, or upon change of measured CBR).

Method 200 depicted in FIG. 2 includes receiving 410 a configuration for SLRB. Method 400 includes receiving 420 data and/or resource (re) selection triggers. At 430, method 400 includes determining if a duplication condition for the SLRB is satisfied. This condition may include those described herein, including, but not limited to, preemption and remaining PDB.

Resource selection on one or more carriers in which the SLRB is configured to use may trigger duplication. Upon resource selection, if the resource selection results in a periodic (multi-shot) resource where the selected resource occurs less than a threshold after the remaining PDB of the data which triggered resource selection, the WTRU may enable duplication. The data considered in such a criteria (i.e., the data that triggered the resource selection) may further be associated with data of the SLRB considered for duplication. The time threshold may be configured per SLRB. Furthermore, a WTRU may perform such an action for a SLRB as long as the time threshold is configured for that SLRB.

Following resource selection, a WTRU may perform preemption following detection of another transmission by another WTRU on the selected resource. Following such a detection, the WTRU may also enable duplication (if not already enabled). The WTRU may enable duplication if the preemption occurs on a resource/grant which is being used or may be used for transmission of data associated with the SLRB configured to allow duplication.

If the determining 430 is negative, method 400 may return to receiving 420. If the determining 430 is affirmative, at 440, method 400 includes enabling duplication for the SLRB. After enabling 440, method 400 includes monitoring/checking 450 for duplication disable condition for the SLRB. Following the enabling of duplication, the WTRU may continue to perform duplication until, for broadcast, the time difference between the selected resource and the PDB of packets is above a threshold a number of consecutive times, and for unicast, the number of consecutive HARQ ACKs received from transmissions containing data from the SLRB reaches a threshold value.

When the monitoring/checking 450 identifies a disable condition, at 460, method 400 determines if the duplication disable condition for SLRB is satisfied. If the determination 460 is negative, method 400 continues by monitoring/checking 450. If the determination 460 is affirmative, method 400 disables 470 duplication for the SLRB.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random-access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a UE, WTRU, terminal, base station, RNC, or any host computer.

1. A method performed in wireless transmit and receive unit (WTRU) to provide duplication on a plurality of sidelink (SL) carriers, the method comprising:
receiving information indicating a configuration for sidelink radio bearer (SLRB);
determining to enable packet data convergence protocol (PDCP) duplication for the SLRB based on sensing results, wherein the sensing results are based on a condition indicated in the configuration; and
duplicating each protocol data unit (PDU) from the SLRB, wherein the duplicating is configured to occur on at least two of the plurality of SL carriers for a period of time following the determination to enable duplication.

2. The method of claim 1, further comprising monitoring for a condition to disable PDCP duplication.

3. The method of claim 2, wherein the condition to disable PDCP duplication is a received signal.

4. The method of claim 2, wherein the condition to disable PDCP duplication includes an expiration of the period of time.

5. The method of claim 1, further comprising receiving information indicating the configuration of the plurality of SL carriers.

6. The method of claim 1, wherein the sensing results includes a determination that the condition indicated in the configuration is satisfied.

7. The method of claim 1, wherein the configuration for SLRB includes a threshold time difference between a selected resource and a packet delay budget (PDB).

8. The method of claim 7, wherein the condition includes the threshold time difference.

9. The method of claim 1, wherein the configuration for SLRB includes the period of time to duplicate PDUs.

10. The method of claim 1, wherein the condition indicated in the configuration is a reception of data.

11. The method of claim 1, wherein the condition includes preemption based on receipt of information from another SL WTRU that is configured to change a plurality of selected resources of the WTRU.

12. The method of claim 1, wherein the condition is associated with remaining PDBs.

13. A wireless transmit and receive unit (WTRU) configured to provide duplication on a plurality of sidelink (SL) carriers, the WTRU comprising:
a transceiver for enabling communication of the WTRU; and
a processor operatively coupled to the transceiver to:
receive information indicating a configuration for sidelink radio bearer (SLRB);
determine to enable packet data convergence protocol (PDCP) duplication for the SLRB based on sensing results, wherein the sensing results are based on a condition indicated in the configuration; and
duplicate each protocol data unit (PDU) from the SLRB, wherein the duplicating is configured to occur on at least two of the plurality of SL carriers for a period of time following the determination to enable duplication.

14. The WTRU of claim 13, wherein the processor and transceiver are operatively coupled to further monitor for a condition to disable PDCP duplication.

15-16. (canceled)

17. The WTRU of claim 13, wherein the processor and transceiver are operatively coupled to further receive information indicating the configuration of the plurality of SL carriers.

18. The WTRU of claim 13, wherein the sensing results includes a determination that the condition indicated in the configuration is satisfied.

19. The WTRU of claim 13, wherein the configuration for SLRB includes a threshold time difference between a selected resource and a packet delay budget (PDB).

20. (canceled)

21. The WTRU of claim 13, wherein the configuration for SLRB includes the period of time to duplicate PDUs.

22. The WTRU of claim 13, wherein the condition indicated in the configuration is a reception of data.

23. The WTRU of claim 13, wherein the condition includes preemption based on receipt of information from another SL WTRU that is configured to change a plurality of selected resources of the WTRU.

24. (canceled)
